(19) United States
(12) Patent Application Publication
(10) Pub. No.: US 2019/0270844 A1
(43) Pub. Date: Sep. 5, 2019

(54) HOMOGENEOUS AMORPHOUS HIGH HEAT EPOXY BLEND COMPOSITE COMPOSITIONS, ARTICLES, AND USES THEREOF

(71) Applicant: SABIC GLOBAL TECHNOLOGIES B.V., BERGEN OP ZOOM (NL)

(72) Inventors: Edward Norman PETERS, Selkirk, NY (US); Prakash SISTA, Mt. Vernon, IN (US)

(21) Appl. No.: 16/333,099

(22) PCT Filed: Mar. 13, 2017
(86) PCT No.: PCT/US2017/022139

§ 371 Date: Mar. 13, 2019

Related U.S. Application Data
(60) Provisional application No. 62/399,864, filed on Sep. 26, 2016.

(51) Int. Cl. C08G 59/24; C08G 59/26; C08J 5/04; C08J 5/24; C08L 63/10

(52) U.S. Cl. CPC C08G 59/245; C08G 59/26; C08J 2363/00; C08J 5/24; C08L 63/10; C08J 5/042

(57) ABSTRACT

A high heat epoxy prepreg, comprising a substrate; a high heat epoxy composition comprising: a hardener; a high heat epoxy mixture comprising: a high heat epoxy compound and an auxiliary epoxy compound different from the high heat epoxy compound; wherein the high heat epoxy mixture has a glass transition temperature between −10 C and 62 C, wherein the prepreg comprises 40 to 80 volume % substrate, and 60 to 20 volume % of the high heat epoxy composition, wherein the prepreg comprises 12 to 45 volume % of the high heat epoxy compound; wherein the high heat epoxy composition comprises 50 to 75 wt % of the high heat epoxy compound; and a cured, laminated sample of the prepreg has a maximum tensile stress of 800 MPa or greater, measured as per ASTM D 3039, and a modulus of 70 GPa or greater measured as per ASTM D 3039; and a cured sample of the high heat epoxy composition has a glass transition temperature greater than 200 C.

### CROSS-REFERENCE TO RELATED APPLICATIONS

This application claims priority to U.S. provisional application Ser. No. 62/399,864, filed Sep. 26, 2016, the contents of which is hereby incorporated by reference.

### BACKGROUND

Polymer-reinforced fiber composite materials, such as sheets and tapes, are used in a variety of applications. The polymers used in composite materials have many functions, including holding the fibers in place, protecting the fibers from the environment, and providing good aesthetics. The polymers used in composite materials can also deform and distribute stress applied to the fibers, improve impact and fracture resistance of the composite, enhance transverse properties of the laminate, and carry interlaminar shear. Polymers used in matrix materials for applications desirably have high glass transition temperature, low moisture absorption, low shrinkage, and good fracture toughness.

Epoxy polymers are used in a wide variety of applications including protective coatings, adhesives, electronic laminates, flooring and paving applications, glass fiber-reinforced pipes, and automotive parts. In their cured form, epoxy polymers offer desirable properties including good adhesion to other materials, excellent resistance to corrosion and chemicals, high tensile strength, and good electrical resistance. However, cured epoxy polymers can be brittle and lack toughness.

There is a need for epoxy-based composite materials with improved properties.

### SUMMARY

A high heat epoxy prepreg comprises a substrate, preferably carbon fibers; a high heat epoxy composition comprising: a hardener; a high heat epoxy mixture comprising: a high heat epoxy compound having formula:

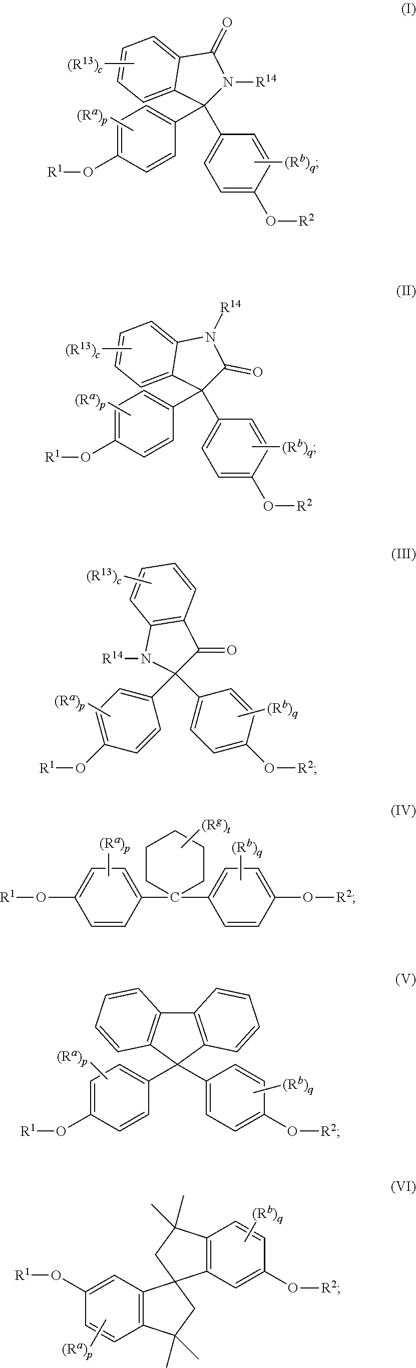

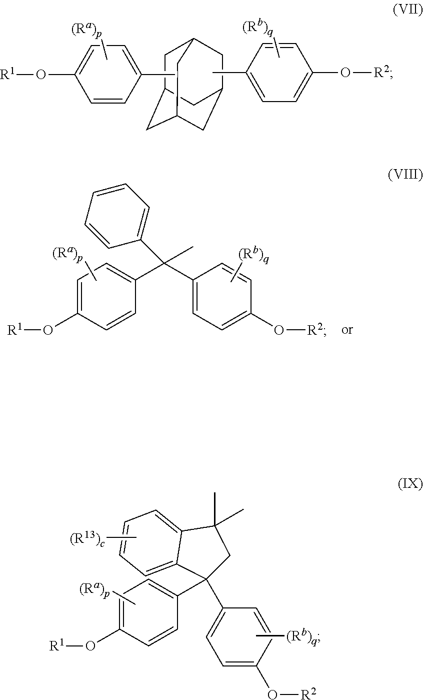

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; and an auxiliary epoxy compound different from the high heat epoxy compound; wherein the high heat epoxy mixture has a glass transition temperature between −10° C. and 62° C., preferably between 15° C. and 62° C., preferably between 30° C. and 62° C., preferably between 40° C. and 62° C., wherein the prepreg comprises 40 to 80 volume %, preferably 50 to 70 volume % substrate, and 60 to 20 volume % of the high heat epoxy composition, wherein the prepreg comprises 12 to 45 volume % of the compound having formula (I) to (IX); wherein the high heat epoxy composition comprises 50 to 75 wt % of the compound having formula (I) to (IX); and a cured, laminated sample of the prepreg has a maximum tensile stress of 800 MPa or greater, measured as per ASTM D 3039, and a modulus of 70 GPa or greater measured as per ASTM D 3039; and a cured sample of the high heat epoxy composition has a glass transition temperature greater than 200° C., preferably greater than 220° C., preferably greater than 230° C. is provided.

A method of manufacturing a high heat epoxy based prepreg comprises coating a substrate with a provided high heat epoxy composition to form the PPPBP-epoxy based prepreg is provided. A prepreg formed by a provided method is provided. A high heat epoxy composite produced by consolidating a provided prepreg is provided. An article comprising a provided composite is provided.

The above described and other features are exemplified by the following detailed description.

### DRAWINGS

Referring now to the Figures, which are exemplary embodiments,

FIG. 1 is a comparison of storage modulus (Pa) and loss modulus (Pa) for two formulations: ECN+TGDDM+MDEA (triangles) and PPPBP+TGAP+MDEA (squares).

FIG. 2 shows the curing reaction rate of two formulations: ECN+TGDDM+MDEA (triangles) and PPPBP+TGAP+MDEA (squares).

FIGS. 3A and 3B are Scanning Electron Microscopy images (2000×) showing in FIG. 3A a composite-prepared with PPPBP-epoxy, and in FIG. 3B a comparative composite prepared with an epoxy cresol novolac.

### DETAILED DESCRIPTION

The inventors hereof have discovered compositions that provide desirable properties in composite materials.

In an embodiment, provided is a high heat epoxy prepreg, comprising a substrate, and a high heat epoxy composition comprising: a hardener; a high heat epoxy mixture comprising a high heat epoxy compound and an auxiliary epoxy compound different from the high heat epoxy compound. In an embodiment, the prepreg comprises 40 to 80 volume % substrate. In an embodiment, the prepreg comprises 50 to 70 volume % substrate. In an embodiment, the prepreg comprises 60 to 20 volume % of the high heat epoxy composition. In an embodiment, the prepreg comprises 12 to 45 volume % of the high heat epoxy compound. In an embodiment, the high heat epoxy composition comprises 50 to 75 wt % of the high heat epoxy compound. In an embodiment, a cured, laminated sample of the prepreg has a maximum tensile stress of 800 MPa or greater, measured as per ASTM D 3039, and a modulus of 70 GPa or greater measured as per ASTM D 3039; and a cured sample of the high heat epoxy composition has a glass transition temperature greater than 200° C. In an embodiment, a cured sample of the high heat epoxy composition has a glass transition temperature greater than 220° C. In an embodiment, a cured sample of the high heat epoxy composition has a glass transition temperature greater than 230° C.

The substrate can be any suitable material that can be coated with the high heat epoxy composition. The substrate can include organic or inorganic materials such as wood, cellulose, metal, glass, carbon (e.g., pyrolyzed carbon, graphite, graphene, nanofibers, or nanotubes), polymer, ceramic, or the like. A combination of different materials can be used. In an embodiment, an electrically conductive material, e.g., a metal such as copper or aluminum, or an alloy thereof, can be used. In some embodiments a fibrous substrate is used. The fiber can be inorganic fiber, for example ceramic fiber, boron fiber, silica fiber, alumina fiber, zirconia fiber, basalt fiber, metal fiber, or glass fiber; or organic fiber, for example a carbon fiber or polymer fiber. The fibers can be coated with a layer of conductive material to facilitate conductivity. The fibers can be monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. The fibrous substrate can be a woven or co-woven fabric (such as 0 to 90 degree fabrics or the like), a non-woven fabric (such as a continuous strand mat, chopped strand mat, tissues, papers, felts, or the like), plain weave cloth, satin weave cloth, non-crimp fabric, unidirectional fibers, braids, tows, ends, roving, rope, or a combination including at least one of the foregoing. Co-woven structures include glass fiber-carbon fiber, carbon fiber-aromatic polyimide (aramid) fiber, and aromatic polyimide fiberglass fiber. In some embodiments the substrate can include a glass fiber, a carbon fiber, or a combination including at least one of the foregoing. The substrate can be a carbon fiber tow. A carbon fiber tow can include any number of individual carbon fiber filaments, such as 6,000, 12,000, 18,000, 24,000, 60,000, or 80,000.

In embodiments, the substrate can be a high modulus carbon-fiber, intermediate modulus carbon-fiber, high strength carbon-fiber, E-glass, S-glass, aramid fiber, or a combination comprising at least one of the foregoing.

In embodiments, the high heat epoxy compound has formula (I) to (IX):

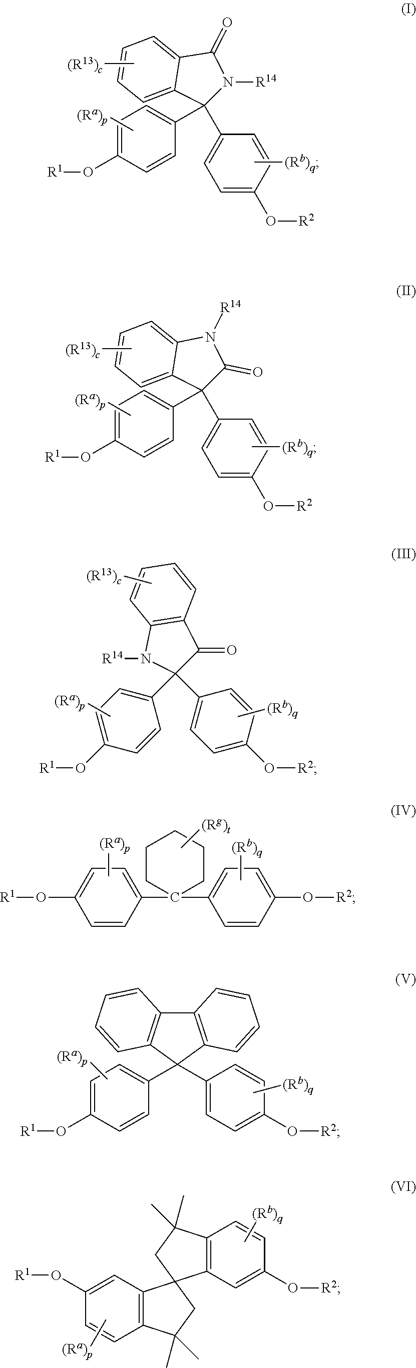

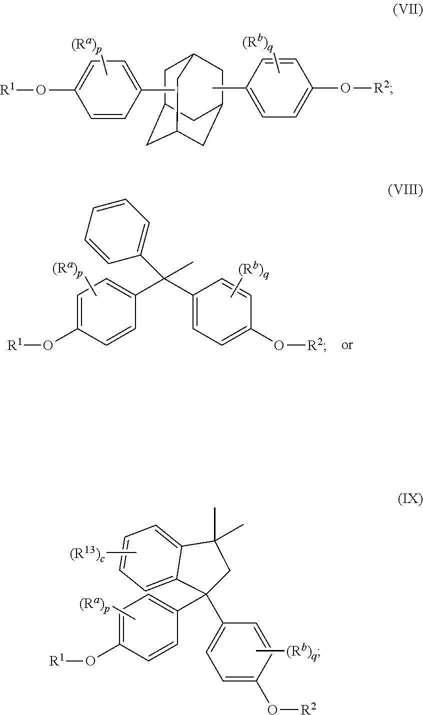

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10.

In embodiments, R¹ and R² at each occurrence can each be independently:

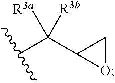

wherein R^{3a} and R^{3b} are each independently hydrogen or C₁-C₁₂ alkyl. In certain embodiments, R¹ and R² are each independently

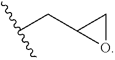 [SMILES: *CC1CO1]

In embodiments, the high heat epoxy compound has the formula

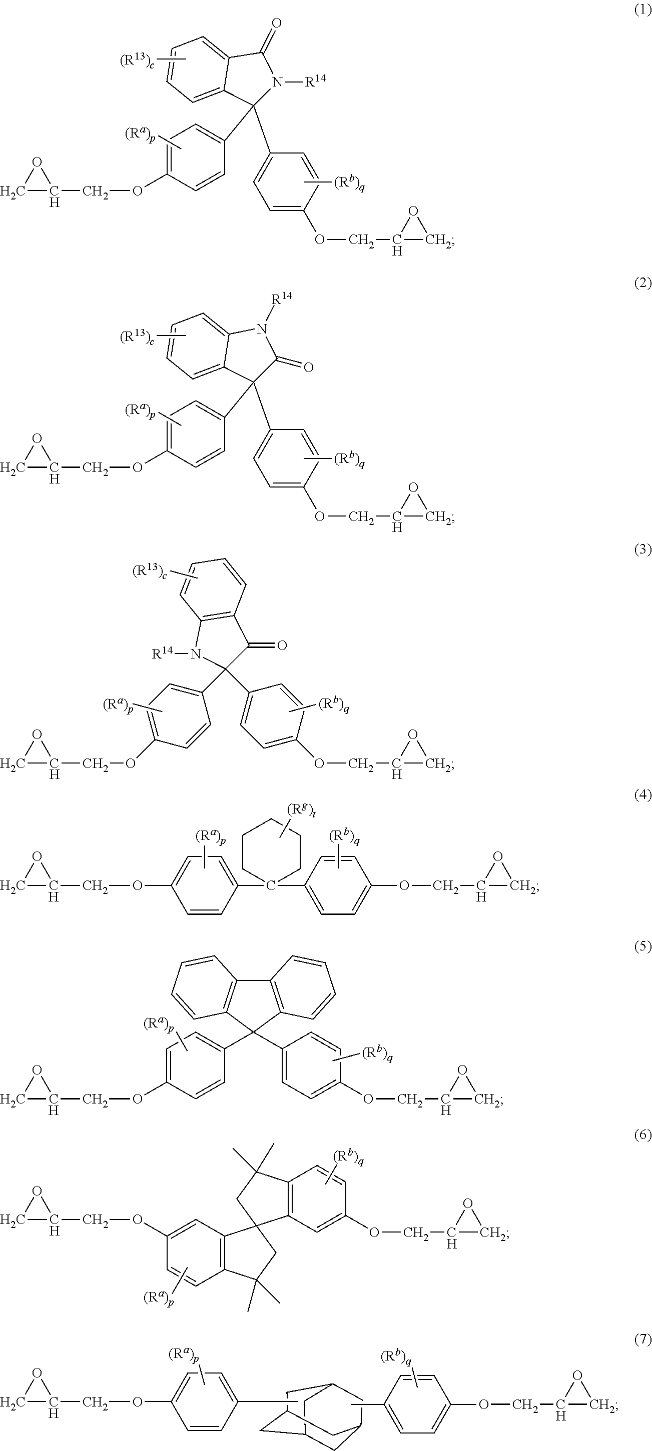

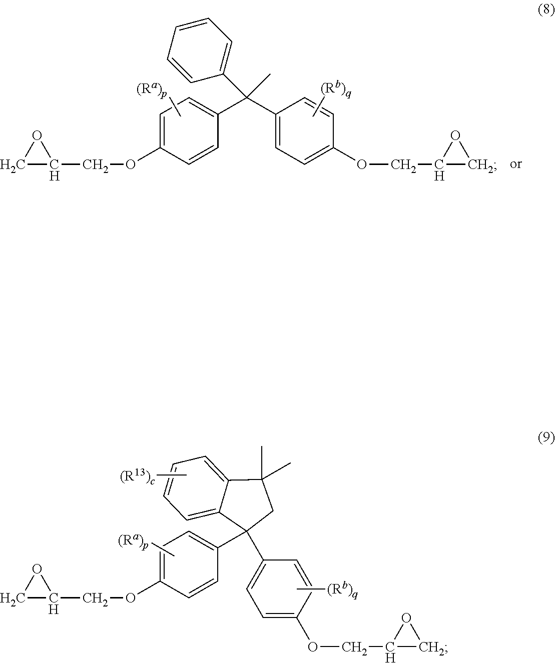

wherein R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10.

In some embodiments, R^{a} and R^{b} at each occurrence are each independently halogen, C₁-C₁₂, alkyl, or C₁-C₁₂, alkoxy; p and q at each occurrence are each independently 0 to 2; R¹³ at each occurrence is independently a halogen or a C₁-C₃ alkyl group; c at each occurrence is independently 0 to 2; R¹⁴ at each occurrence is independently a C₁-C₆ alkyl or phenyl; R^{g} at each occurrence is independently C₁-C₁₂ alkyl, or two R^{g} groups together with the carbon atoms to which they are attached form a four-, five, or six-membered cycloalkyl group; and t is 1 to 5.

In some embodiments, R^{a} and R^{b} at each occurrence are each independently C₁-C₆ alkyl, or C₁-C₆ alkoxy; p and q at each occurrence are each independently 0 to 2; R¹³ at each occurrence is independently a C₁-C₃ alkyl group; c at each occurrence is independently 0 to 2; R¹⁴ at each occurrence is independently a C₁-C₃ alkyl or phenyl; R^{g} at each occurrence is independently C₁-C₆ alkyl; and t is 1 to 5.

In embodiments, the high heat epoxy compound has the formula (1-a), (2-a), or (4-b)

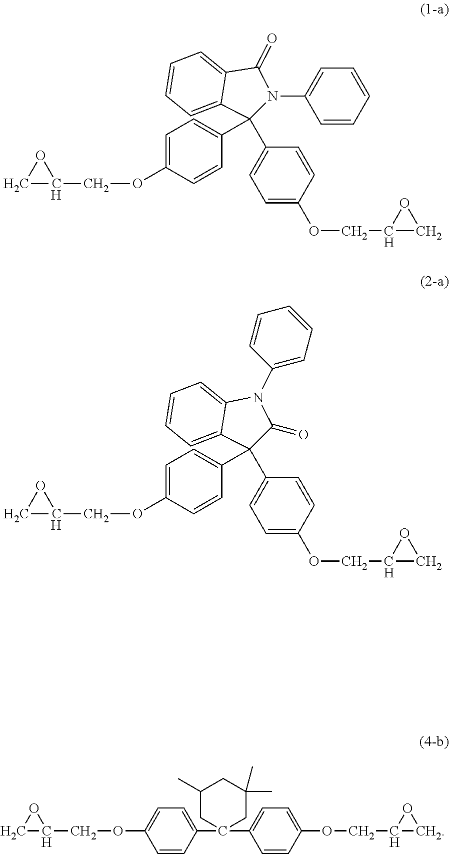 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

In an embodiment. the high heat epoxy compound has the formula (1-a)

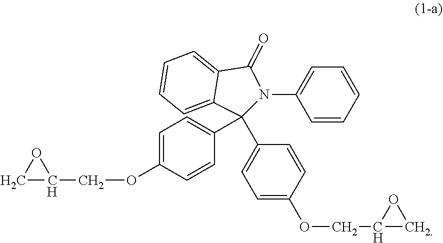 [SMILES: O=C1c2ccccc2C(c2ccc(OCC3CO3)cc2)(c2ccc(OCC3CO3)cc2)N1c1ccccc1]

The high heat epoxy compound can be prepared by methods described in, for example, WO2016/014536. The high heat epoxy compound can be from a corresponding bisphenol compound [e.g., a bisphenol of formula (1′) to (9′)].

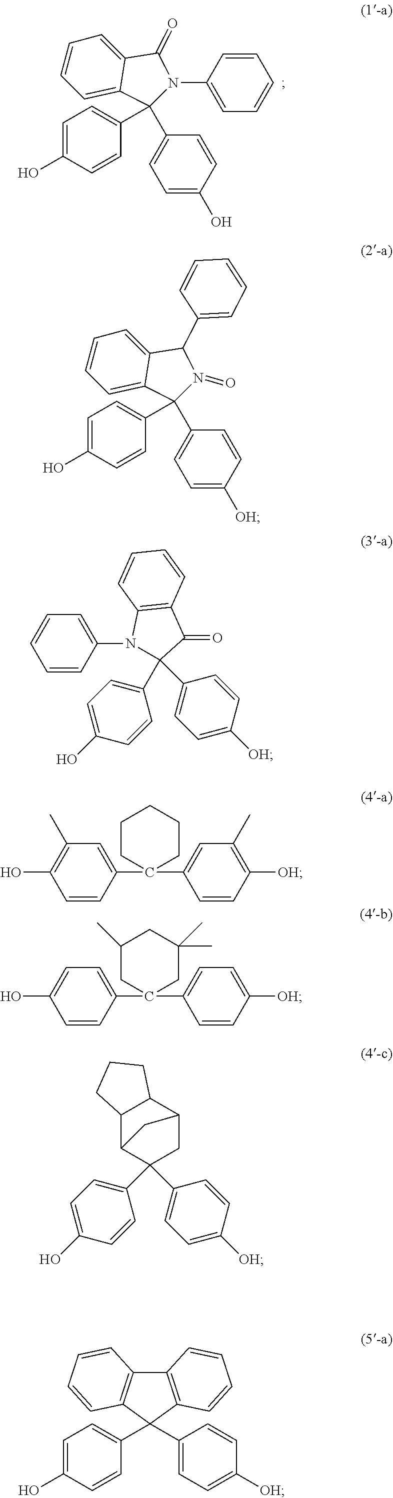

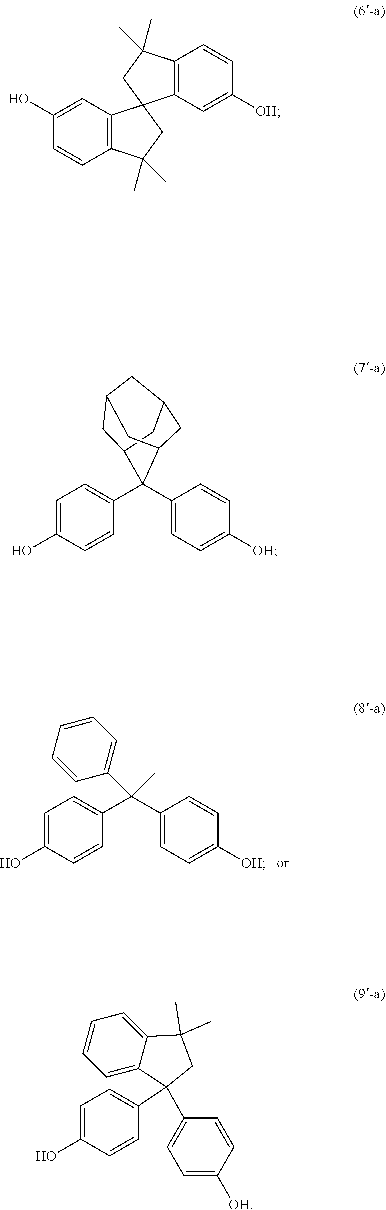 [SMILES: CC1(C)CC2(CC(C)(C)c3ccc(O)cc32)c2cc(O)ccc21 ; Oc1ccc(C2(c3ccc(O)cc3)C3CC4CC(C3)CC2C4)cc1 ; CC(c1ccccc1)(c1ccc(O)cc1)c1ccc(O)cc1 ; CC1(C)CC(c2ccc(O)cc2)(c2ccc(O)cc2)c2ccccc21]

The bisphenol can be provided in a mixture with an epoxide source, such as epichlorohydrin. The resultant mixture can be treated with a catalytic amount of base at a selected temperature. Suitable bases include, but are not limited to, carbonates (e.g., sodium bicarbonate, ammonium carbonate, or dissolved carbon dioxide), and hydroxide bases (e.g., sodium hydroxide, potassium hydroxide, or ammonium hydroxide). The base may be added as a powder (e.g., powdered sodium hydroxide). The base may be added slowly (e.g., over a time period of 60 to 90 minutes). The temperature of the reaction mixture may be maintained at 20° C. to 24° C., for example. The reaction may be stirred for a selected time period (e.g., 5 hours to 24 hours, or 8 hours to 12 hours). The reaction may be quenched by addition of an aqueous solvent, optionally along with one or more organic solvents (e.g., ethyl acetate). The aqueous layer can be extracted (e.g., with ethyl acetate), and the organic extract can be dried and concentrated. The crude product can be purified (e.g., by silica gel chromatography) and isolated. The isolated product may be obtained in a yield of 80% or greater, 85% or greater, or 90% or greater.

In certain embodiments, the composition may comprise a high heat epoxy compound wherein the purity is 95% or greater, preferably 97% or greater, preferably 99% or greater, as determined by high performance liquid chromatography (HPLC). WO 2016/014536A1 and US Publication 2015/041338 disclose that high purity epoxy with low oligomer content exhibits lower viscosity, which can facilitates fiber wet out during processing to make prepgregs and laminates.

The high heat epoxy compound can have a metal impurity content of 3 ppm or less, 2 ppm or less, 1 ppm or less, 500 ppb or less, 400 ppb or less, 300 ppb or less, 200 ppb or less, or 100 ppb or less. The metal impurities may be iron, calcium, zinc, aluminum, or a combination thereof. The compounds can have an unknown impurities content of 0.1 wt % or less. The compounds can have a color APHA value of 40 or less, 35 or less, 30 or less, 25 or less, 20 or less, 19 or less, 18 or less, 17 or less, 16 or less, or 15 or less, as measured using test method ASTM D1209.

The high heat epoxy compounds can be substantially free of epoxide oligomer impurities. The epoxides can have an oligomer impurity content of less than or equal to 3%, less than or equal to 2%, less than or equal to 1%, less than or equal to 0.5%, less than or equal to 0.4%, less than or equal to 0.3%, less than or equal to 0.2%, or less than or equal to 0.1%, as determined by high performance liquid chromatography. The epoxides can have an epoxy equivalent weight corresponding to purity of the bisepoxide of 95% purity or greater, 96% purity or greater, 97% purity or greater, 98% purity or greater, 99% purity or greater, or 100% purity. Epoxy equivalent weight (EEW) is the weight of material in grams that contains one mole of epoxy groups. It is also the molecular weight of the compound divided by the number of epoxy groups in one molecule of the compound.

The high heat epoxy composition includes an auxiliary epoxy compound different from the high heat epoxy compound. In an embodiment, the high heat epoxy composition includes 1 to 50 wt % of the auxiliary epoxy compound. In an embodiment, the high heat epoxy composition includes 1 to 25 wt % of the auxiliary epoxy compound. In an embodiment, the high heat epoxy composition includes 1 to 10 wt % of the auxiliary epoxy compound.

In embodiments, the auxiliary epoxy compound is an aliphatic epoxy compound, cycloaliphatic epoxy compound, aromatic epoxy compound, bisphenol A epoxy compound, bisphenol-F epoxy compound, phenol novolac epoxy polymer, cresol-novolac epoxy polymer, biphenyl epoxy compound, triglycidyl p-aminophenol, tetraglycidyl diamino diphenyl methane, polyfunctional epoxy compound, naphthalene epoxy compound, divinylbenzene dioxide compound, 2-glycidylphenylglycidyl ether, dicyclopentadiene-type epoxy compound, multi aromatic type epoxy polymer, bisphenol-S type epoxy compound, isocyanurate type epoxy compound, hydantoin type epoxy compound or a combination comprising at least one of the foregoing. In embodiments, the auxiliary epoxy compound is a bisphenol A diglycidylether, a bisphenol F diglycidylether, a neopentylglycol diglycidyl ether, a 3,4-epoxycyclohexylmethyl-3,4-epoxycyclohexane carboxylate, N,N-diglycidyl-4-glycidyloxyaniline, a N,N,N′,N′-tetraglycidyl-4,4′-diaminodiphenylmethane, or a combination comprising at least one of the foregoing.

The auxiliary epoxy compound can have formula

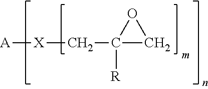

wherein A is an organic or inorganic radical of valence n, X is oxygen or nitrogen, m is 1 or 2 and consistent with the valence of X, R is hydrogen or methyl, n is 1 to 1000, specifically 1 to 8, more specifically 2 or 3 or 4.

Other auxiliary epoxy compounds include, for example, halogenated hydantoin epoxy compounds, triphenylmethane epoxy compounds, tetra phenyl-glycidyl-ether of tetraphenyl ethane (4 functionality epoxy compound), and novolac type epoxy compounds.

Auxiliary epoxy compounds include those having the following structures:

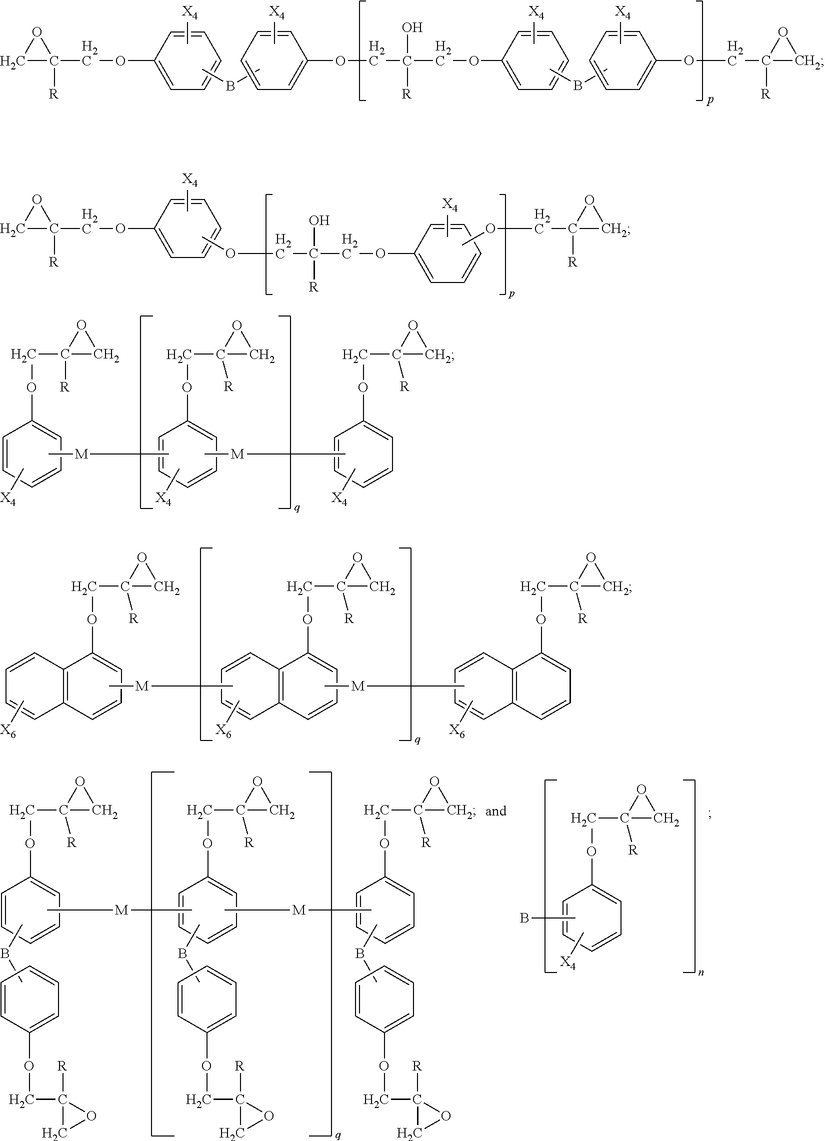

wherein each occurrence of R is independently hydrogen or methyl; each occurrence of M is independently C1-C18 hydrocarbylene optionally further comprising an oxirane, carboxy, carboxamide, ketone, aldehyde, alcohol, halogen, or nitrile; each occurrence of X is independently hydrogen, chloro, fluoro, or bromo, C1-C18 hydrocarbyl optionally further comprising a carboxy, carboxamide, ketone, aldehyde, alcohol, halogen, or nitrile; each occurrence of B is independently a carbon-carbon single bond, C1-C18 hydrocarbyl, C1-C12 hydrocarbyloxy, C1-C12 hydrocarbylthio, carbonyl, sulfide, sulfonyl, sulfinyl, phosphoryl, silane, or such groups further comprising a carboxyalkyl, carboxamide, ketone, aldehyde, alcohol, halogen, or nitrile; n is 1 to 20; and each occurrence of p and q is independently 0 to 20.

Auxiliary epoxy compounds for many applications include those produced by the reaction of epichlorohydrin or epibromohydrin with a phenolic compound. Suitable phenolic compounds include resorcinol, catechol, hydroquinone, 2,6-dihydroxynaphthalene, 2,7-dihydroxynapthalene, 2-(diphenylphosphoryl)hydroquinone, bis(2,6-dimethylphenol)2,2′-biphenol, 4,4′-biphenol, 2,2′,6,6′-tetramethylbiphenol, 2,2′,3,3′,6,6′-hexamethylbiphenol, 3,3′,5,5′-tetrabromo-2,2′6,6′-tetramethylbiphenol, 3,3′-dibromo-2,2′,6,6′-tetramethylbiphenol, 2,2′,6,6′-tetramethyl-3,3′5-tribromobiphenol, 4,4′-isopropylidenediphenol (bisphenol A), 4,4′-isopropylidenebis(2,6-dibromophenol) (tetrabromobisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4,4′-(1,3-phenylenediisopropylidene)bisphenol (bisphenol M), 4,4′-isopropylidenebis(3-phenylphenol), 4,4′-(1,4-phenylenediisoproylidene)bisphenol (bisphenol P), 4,4′-ethylidenediphenol (bisphenol E), 4,4′-oxydiphenol, 4,4′-thiodiphenol, 4,4′-thiobis(2,6-dimethylphenol), 4,4′-sulfonyldiphenol, 4,4′-sulfonylbis(2,6-dimethylphenol) 4,4′-sulfinyldiphenol, 4,4′-hexafluoroisoproylidene)bisphenol (Bisphenol AF), 4,4′-(1-phenylethylidene)bisphenol (Bisphenol AP), bis(4-hydroxyphenyl)-2,2-dichloroethylene (Bisphenol C), bis(4-hydroxyphenyl)methane (Bisphenol-F), bis(2,6-dimethyl-4-hydroxyphenyl)methane, 4,4′-(cyclopentylidene)diphenol, 4,4′-(cyclohexylidene)diphenol (Bisphenol Z), 4,4′-(cyclododecylidene)diphenol 4,4′-(bicyclo[2.2.1]heptylidene)diphenol, 4,4′-(9H-fluorene-9,9-diyl)diphenol, 3,3-bis(4-hydroxyphenyl)isobenzofuran-1(3H)-one, 1-(4-hydroxyphenyl)-3,3-dimethyl-2,3-dihydro-1H-inden-5-ol, 1-(4-hydroxy-3,5-dimethylphenyl)-1,3,3,4,6-pentamethyl-2,3-dihydro-1H-inden-5-ol, 3,3,3′,3′-tetramethyl-2,2′,3,3′-tetrahydro-1,1′-spirobi[indene]-5,6′-diol (spirobiindane), dihydroxybenzophenone (bisphenol K), tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane, tetrakis(3,5-dimethyl-4-hydroxyphenyl)ethane, bis(4-hydroxyphenyl)phenylphosphine oxide, dicyclopentadienylbis(2,6-dimethyl phenol), dicyclopentadienyl bis(2-methylphenol), dicyclopentadienyl bisphenol, and the like and mixtures thereof. In some examples, the epoxy compound comprises a bisphenol A diglycidylether epoxy compound.

Other suitable auxiliary epoxy compounds include N-glycidyl phthalimide, N-glycidyltetrahydrophthalimide, phenyl glycidyl ether, p-butylphenyl glycidyl ether, styrene oxide, neohexene oxide, ethylene glycol diglycidyl ether, polyethylene glycol diglycidyl ether, propylene glycol diglycidyl ether, polypropylene glycol diglycidyl ether, tetramethyleneglycol diglycidyl ether, polytetramethylene glycol diglycidyl ether, resorcinol-type epoxy compounds, phenol novolac-type epoxy compounds, ortho-cresol novolac-type epoxy compounds, adipic acid diglycidyl ester, sebacic acid diglycidyl ester, and phthalic acid diglycidyl ester.

Other auxiliary epoxy compounds include the glycidyl ethers of phenolic compounds such as the glycidyl ethers of phenol-formaldehyde novolac, alkyl substituted phenol-formaldehyde compounds including cresol-formaldehyde novolac, t-butylphenol-formaldehyde novolac, sec-butylphenol-formaldehyde novolac, tert-octylphenol-formaldehyde novolac, cumylphenol-formaldehyde novolac, decylphenol-formaldehyde novolac. Other useful auxiliary epoxy compounds are the glycidyl ethers of bromophenol-formaldehyde novolac, chlorophenolformaldehyde novolac, phenol-bis(hydroxymethyl)benzene novolac, phenol-bis(hydroxymethylbiphenyl) novolac, phenol-hydroxybenzaldehyde novolac, phenol-dicylcopentadiene novolac, naphthol-formaldehyde novolac, naphthol-bis(hydroxymethyl)benzene novolac, naphthol-bis(hydroxymethylbiphenyl) novolac, naphthol-hydroxybenzaldehyde novolac, and naphthol-dicylcopentadiene novolacs, and the like, and mixtures thereof.

Other suitable auxiliary epoxy compounds include the polyglycidyl ethers of polyhydric aliphatic alcohols. Examples of such polyhydric alcohols include 1,4-butanediol, 1,6-hexanediol, polyalkylene glycols, glycerol, trimethylolpropane, 2,2-bis(4-hydroxycyclohexyl)propane, and pentaerythritol.

Further suitable auxiliary epoxy compounds are polyglycidyl esters which are obtained by reacting epichlorohydrin or similar epoxy compounds with an aliphatic, cycloaliphatic, or aromatic polycarboxylic acid, such as oxalic acid, adipic acid, glutaric acid, phthalic, isophthalic, terephthalic, tetrahydrophthalic or hexahydrophthalic acid, 2,6-naphthalenedicarboxylic acid, and dimerized fatty acids. Examples are diglycidyl terephthalate and diglycidyl hexahydrophthalate. Moreover, polyepoxide compounds which contain the epoxide groups in random distribution over the molecule chain and which can be prepared by emulsion copolymerization using olefinically unsaturated compounds that contain these epoxide groups, such as, for example, glycidyl esters of acrylic or methacrylic acid, can be used.

Examples of further auxiliary epoxy compounds that can be used are those based on heterocyclic ring systems, for example hydantoin epoxy compounds, triglycidyl isocyanurate and its oligomers, triglycidyl-p-aminophenol, triglycidyl-p-aminodiphenyl ether, tetraglycidyldiaminodiphenylmethane, tetraglycidyldiaminodiphenyl ether, tetrakis(4-glycidyloxyphenyl)ethane, urazole epoxides, uracil epoxides, and oxazolidinone-modified epoxy compounds.

Other examples of auxiliary epoxy compounds are polyepoxides based on aromatic amines, such as aniline, for example N,N-diglycidylaniline, diaminodiphenylmethane and cycloaliphatic epoxy compounds such as 3,4-epoxycyclohexylmethyl-3,4-epoxycyclohexane carboxylate, 4,4′-(1,2-epoxyethyl)biphenyl, 4,4′-di(1,2-epoxyethyl)diphenyl ether, and bis(2,3-epoxycyclopentyl)ether.

Other examples of auxiliary epoxy compounds are mixed multifunctional epoxy compounds obtained from compounds that contain a combination of functional groups mentioned above, for example, 4-aminophenol.

Examples of mono-functional auxiliary epoxy compounds include 2-ethylhexyl glycidyl ether, butyl glycidyl ether, phenyl glycidyl ether, t-butyl glycidyl ether, o-cresyl glycidyl ether, and nonyl phenol glycidyl ether.

Oxazolidinone-modified auxiliary epoxy compounds can also be used, such as those disclosed in Angew. Makromol. Chem., vol. 44, (1975), pages 151-163, and U.S. Pat. No. 3,334,110 to Schramm An example is the reaction product of bisphenol A diglycidyl ether with diphenylmethane diisocyanate in the presence of an appropriate accelerator.

Auxiliary epoxy compounds can be prepared by condensation of an epoxy compound with a phenol such as a bisphenol. A typical example is the condensation of bisphenol A with a bisphenol A diglycidyl ether to produce an oligomeric diglycidyl ether. In another example a phenol dissimilar to the one used to derive the epoxy compound may be used. For example tetrabromobisphenol A may be condensed with bisphenol A diglycidyl ether to produce an oligomeric diglycidyl ether containing halogens.

The auxiliary epoxy compound can be a solid at room temperature. Thus, in some embodiments, the epoxy compound has a softening point of 25° C. to 150° C. The auxiliary epoxy compound can be a liquid or a softened solid at room temperature. Thus, in some embodiments, the auxiliary epoxy compound has a softening point less than 25° C.

The high heat epoxy composition can include a curing promoter. The term “curing promoter” as used herein encompasses compounds whose roles in curing epoxy compounds are variously described as those of a hardener, a hardening accelerator, a curing catalyst, and a curing co-catalyst, among others. The curing promoter can be an aromatic diamine compound, aliphatic diamine compound, phenol, or anhydride. In an embodiment, the curing promoter is a hardener. In an embodiment, the curing promoter can be an aromatic diamine compound.

The amount of curing promoter will depend on the type of curing promoter, as well as the identities and amounts of the other components of the high heat epoxy composition. For example, in an embodiment, when the curing promoter is an aromatic diamine compound, it can be used in an amount of 10 to 30 weight percent of the high heat epoxy composition.

In embodiments, the aromatic diamine compound can be 4-aminophenyl sulfone (DDS), 4,4′-methylenedianiline, diethyltoluenediamine, 4,4′-methylenebis(2,6-diethylaniline), m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine, p-xylylenediamine, diethyl toluene diamines, or a combination comprising at least one of the foregoing. In embodiments, the aromatic dianhydride compound has the general structure

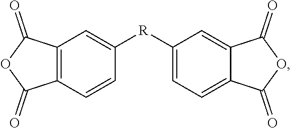

where R can be a single bond,

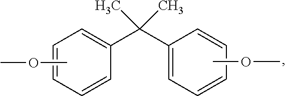

other bisphenols, —C(CF₃)₂—, —O—, or —C(═O)—.

Examples of curing promotors include 4,4′-(4,4′-isopropylidenediphenoxy)bis-(phthalic anhydride) (CAS Reg. No. 38103-06-9), 4,4′-(hexafluoroisopropylidene)diphthalic anhydride (CAS Reg. No. 1107-00-2), 4,4′-oxydiphthalic anhydride (CAS Reg. No. 1823-59-2), benzophenone-3,3′,4,4′-tetracarboxylic dianhydride (CAS Reg. No. 2421-28-5), and 3,3′,4,4′-biphenyltetracarboxylic dianhydride (CAS Reg. No. 2420-87-3), and specifically compounds having the formulas below.

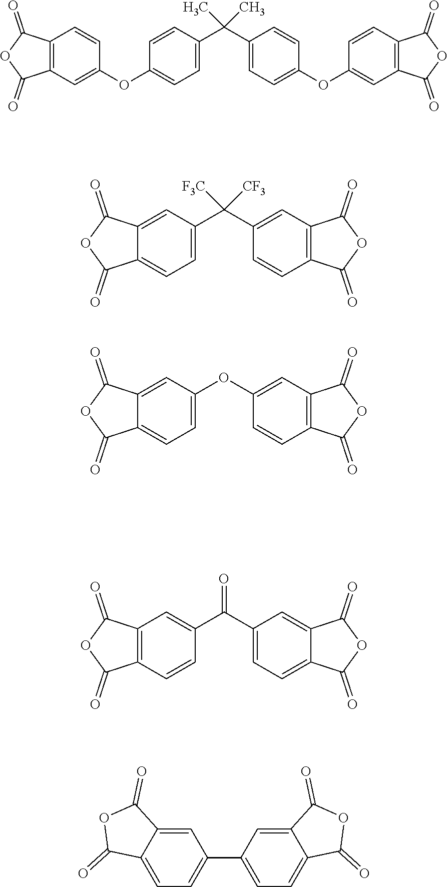 [SMILES: CC(C)(c1ccc(Oc2ccc3c(c2)C(=O)OC3=O)cc1)c1ccc(Oc2ccc3c(c2)C(=O)OC3=O)cc1 ; O=C1OC(=O)c2cc(C(c3ccc4c(c3)C(=O)OC4=O)(C(F)(F)F)C(F)(F)F)ccc21 ; O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(-c3ccc4c(c3)C(=O)OC4=O)ccc21]

The hardener can be a bicyclic anhydride. In embodiments, the bicyclic anhydride compound can be methyl-5-norbornene-2,3-dicarboxylic anhydride (CAS Reg. No. 25134-21-8) and cis-5-norbornene-endo-2,3-dicarboxylic anhydride (CAS Reg. No. 129-64-6) and specifically compounds having the formulas below.

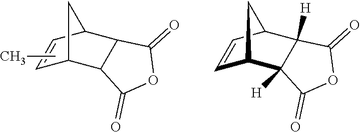

The hardener can, optionally, include a separate curing promoter for epoxy compounds. As used herein, the term “curing promoter” refers to a compound that promotes or catalyzes the epoxy curing reaction without reacting stoichiometrically with the epoxy compounds. Curing promoters for epoxy compounds include, for example, triethylamine, tributylamine, dimethylaniline, diethylaniline, α-methylbenzyldimethylamine, N,N-dimethylaminoethanol, N,N-dimethylaminocresol, tri(N,N-dimethylaminomethyl)phenol, 2-methylimidazole, 2-ethylimidazole, 2-laurylimidazole, 2-heptadecylimidazole, 2-phenylimidazole, 4-methylimidazole, 4-ethylimidazole, 4-laurylimidazole, 4-heptadecylimidazole, 2-phenyl-4-methylimidazole, 2-phenyl-4-hydroxymethylimidazole, 2-ethyl-4-methylimidazole, 2-ethyl-4-hydroxymethylimidazole, 1-cyanoethyl-4-methylimidazole, 2-phenyl-4,5-dihydroxymethylimidazole, and combinations thereof. When present, the curing promoter can be used in an amount of 0.005 to 1 weight percent, specifically 0.01 to 0.5 weight percent, based on the total weight of the composition.

In an embodiment, the composition does not contain a solvent. The high heat epoxy compositions can include a solvent to prepare homogeneous epoxy blends and then the solvent can be removed.

Coating the substrate with the high heat epoxy composition can be by any suitable method, including immersing the substrate into the high heat epoxy composition, for a suitable time, in an embodiment, for up to 30 minutes, in an embodiment, for up to 15 minutes; spraying the high heat epoxy composition onto the substrate; curtain coating the substrate with the high heat epoxy composition, or a combination including at least one of the foregoing.

Heating the coated substrate to form a prepreg can include heating at a temperature from 25 to 100° C. for 1 to 10 hours.

The prepreg can be prepared in any form, where the form is generally dictated by the shape of the substrate. For example, a fabric or a fiber tow can provide a layer of substrate. Where a fiber tow comprising continuous, unidirectional fibers is pre-impregnated, the prepreg is generally referred as a unidirectional tape. The thickness of such layers or tapes can vary widely, for example from 5 micrometers to 1 millimeters (mm).

Composites can be prepared by consolidation of the prepregs by methods known in art. For example, laminates can be prepared by contacting at least two layers of a prepreg under conditions of heat and pressure sufficient to consolidate the prepreg. Effective temperatures can include 100 to 480° C., at pressures from 20 to 2000 pounds per square inch (PSI), for example. A laminate can include at least two layers of the prepreg. In an embodiment, a laminate includes from two to one hundred layers of the prepreg. In some embodiments, all of the layers of the laminate are formed from the prepreg. In other embodiments, the laminate can comprise other layers, for example a different prepreg. In some embodiments, all of the prepreg layers used to form the laminate are the prepregs produced as described herein. In an embodiment, the prepreg layers are in the form of continuous unidirectional fiber-reinforced tapes. In an embodiment, the composite is thermoformed to form a shape. In an embodiment, a cured, laminated sample of the composite has a compression strength of 450 MPa or greater, measured as per ASTM D 6641. In an embodiment, a cured, laminated sample of the composite has a 45° In Plane Shear strength of 80 MPa or greater, measured as per ASTM D3518; and a 45° In Plane Shear modulus of 4 GPa or greater, measured as per ASTM D3518. In an embodiment, a cured, laminated sample of the composite has a Short Beam Shear strength of 60 MPa or greater measured as per ASTM D 2344; and a Short Beam Shear modulus of 120 GPa or greater measured as per ASTM D 2344.

In some embodiments, a non-prepreg layer can be present such as a release layer, a copper foil, or an adhesive to enhance bonding between two layers. The adhesive can be applied using any suitable method, for example, spreading, spraying, and dipping. The adhesive can be any adhesive that provides the desired adhesion between layer(s) of the prepregs or tapes. An adhesive can be polyvinylbutyral (PVB), ethylene-vinyl acetate copolymer (EVA), an epoxy, an ultraviolet (UV) or water-curable adhesive such as a cyanoacrylate or other acrylic, or a combination comprising at least one or the foregoing.

In some embodiments the composite, in particular the laminate, can be thermoformed, for example, vacuum thermoformed, to form a shape.

The high heat epoxy compositions can be used in electronic applications such as encapsulants, adhesives, polymer coated copper, prepregs, and printed circuit boards. In addition, the high heat epoxy compositions can be used in structural composites, industrial adhesives, and coatings.

Methods of forming composites for use in printed circuit boards are known in the art and are described in, for example, U.S. Pat. No. 5,622,588 to Weber, U.S. Pat. No. 5,582,872 to Prinz, and U.S. Pat. No. 7,655,278 to Braidwood.

Additional applications for the high heat epoxy compositions and composites include, for example, acid bath containers; neutralization tanks; aircraft components; bridge beams; bridge deckings; electrolytic cells; exhaust stacks; scrubbers; sporting equipment; stair cases; walkways; automobile exterior panels such as hoods and trunk lids; floor pans; air scoops; pipes and ducts, including heater ducts; industrial fans, fan housings, and blowers; industrial mixers; boat hulls and decks; marine terminal fenders; tiles and coatings; building panels; business machine housings; trays, including cable trays; concrete modifiers; dishwasher and refrigerator parts; electrical encapsulants; electrical panels; tanks, including electrorefining tanks, water softener tanks, fuel tanks, and various filament-wound tanks and tank linings; furniture; garage doors; gratings; protective body gear; luggage; outdoor motor vehicles; pressure tanks; printed circuit boards; optical waveguides; radomes; railings; railroad parts such as tank cars; hopper car covers; car doors; truck bed liners; satellite dishes; signs; solar energy panels; telephone switchgear housings; tractor parts; transformer covers; truck parts such as fenders, hoods, bodies, cabs, and beds; insulation for rotating machines including ground insulation, turn insulation, and phase separation insulation; commutators; core insulation and cords and lacing tape; drive shaft couplings; propeller blades; missile components; rocket motor cases; wing sections; sucker rods; fuselage sections; wing skins and flairings; engine narcelles; cargo doors; tennis racquets; golf club shafts; fishing rods; skis and ski poles; bicycle parts; transverse leaf springs; pumps, such as automotive smog pumps; electrical components, embedding, and tooling, such as electrical cable joints; wire windings and densely packed multi-element assemblies; sealing of electromechanical devices; battery cases; resistors; fuses and thermal cut-off devices; coatings for printed wiring boards; casting items such as capacitors, transformers, crankcase heaters; small molded electronic parts including coils, capacitors, resistors, and semiconductors; as a replacement for steel in chemical processing, pulp and paper, power generation, and wastewater treatment; scrubbing towers; pultruded parts for structural applications, including structural members, gratings, and safety rails; swimming pools, swimming pool slides, hot-tubs, and saunas; drive shafts for under the hood applications; dry toners for copying machines; marine tooling and composites; heat shields; submarine hulls; prototype generation; development of experimental models; laminated trim; drilling fixtures; bonding jigs; inspection fixtures; industrial metal forming dies; aircraft stretch block and hammer forms; vacuum molding tools; flooring, including flooring for production and assembly areas, clean rooms, machine shops, control rooms, laboratories, parking garages, freezers, coolers, and outdoor loading docks; electrically conductive compositions for antistatic applications; for decorative flooring; expansion joints for bridges; injectable mortars for patch and repair of cracks in structural concrete; grouting for tile; machinery rails; metal dowels; bolts and posts; repair of oil and fuel storage tanks, and numerous other applications.

Methods of forming a composite can include impregnating a reinforcing substrate with the high heat epoxy composition; partially curing the high heat epoxy composition to form a prepreg; and laminating a plurality of prepregs; wherein the high heat epoxy composition comprises a high heat epoxy compound and an auxiliary epoxy compound different from the high heat epoxy compound.

Reinforcing substrates suitable for prepreg formation are known in the art. Suitable reinforcing substrates include reinforcing fabrics. Reinforcing fabrics include those having complex architectures, including two or three-dimensional braided, knitted, woven, and filament wound. The high heat epoxy composition is capable of permeating such complex reinforcing substrates. The reinforcing substrate can comprise fibers of materials known for the reinforcement of plastics material, for example fibers of carbon, glass, metal, and aromatic polyamides. Suitable reinforcing substrates are described, for example, in Anonymous (Hexcel Corporation), “Prepreg Technology”, March 2005, Publication No. FGU 017b; Anonymous (Hexcel Corporation), “Advanced Fibre Reinforced Matrix Products for Direct Processes”, June 2005, Publication No. ITA 272; and Bob Griffiths, “Farnborough Airshow Report 2006”, CompositesWorld.com, September 2006. The weight and thickness of the reinforcing substrate are chosen according to the intended use of the composite using criteria well known to those skilled in the production of fiber reinforced polymer composites. The reinforced substrate can contain various finishes suitable for the high heat epoxy composition.

The method of forming the composite comprises partially curing the high heat epoxy composition after the reinforcing substrate has been impregnated with it. Partial curing is curing sufficient to reduce or eliminate the wetness and tackiness of the high heat epoxy composition but not so great as to fully cure the composition. The polymer in a prepreg is customarily in the partially cured state, and those skilled in the thermoset arts, and particularly the reinforced composite arts, understand the concept of partial curing and how to determine conditions to partially cure a polymer without undue experimentation. References herein to properties of the “cured composition” refer to a composition that is substantially fully cured. For example, the polymer in a laminate formed from prepregs is typically substantially fully cured. One skilled in the thermoset arts can determine whether a sample is partially cured or substantially fully cured without undue experimentation. For example, one can analyze a sample by differential scanning calorimetry to look for an exotherm indicative of additional curing occurring during the analysis. A sample that is partially cured will exhibit an exotherm. A sample that is substantially fully cured will exhibit little or no exotherm. Partial curing can be effected by subjecting the matrix-composition-impregnated reinforcing substrate to a temperature of 133 to 140° C. for 4 to 10 minutes, for example.

Commercial-scale methods of forming composites are known in the art, and the high heat epoxy compositions described herein are readily adaptable to existing processes and equipment. For example, prepregs are often produced on treaters. The main components of a treater include feeder rollers, an impregnation tank, a treater oven, and receiver rollers. The reinforcing substrate (E-glass, for example) is usually rolled into a large spool. The spool is then put on the feeder rollers that turn and slowly roll out the reinforcing substrate. The reinforcing substrate then moves through the polymer impregnation tank, which contains the high heat epoxy composition. The varnish impregnates the reinforcing substrate. After emerging from the tank, the coated reinforcing substrate moves upward through the vertical treater oven, which is typically at a temperature of 175 to 200° C., and the solvent of the varnish is boiled away. The matrix begins to polymerize at this time. When the composite comes out of the tower it is sufficiently cured so that the web is not wet or tacky. The cure process, however, is stopped short of completion so that additional curing can occur when laminate is made. The web then rolls the prepreg onto a receiver roll.

While the above-described curing methods rely on thermal curing, it is also possible to effect curing with radiation, including ultraviolet light and electron beams. Combinations of thermal curing and radiation curing can also be used.

In certain embodiments, a composite is formed by a method comprising impregnating a substrate with a high heat epoxy composition; partially curing the high heat epoxy composition to form a prepreg; and laminating a plurality of prepregs; wherein the high heat epoxy composition comprises a high heat epoxy compound, and an auxiliary different from the high heat epoxy compound.

In certain embodiments, a printed circuit board comprises a composite formed by a method comprising impregnating a reinforcing substrate with a high heat epoxy composition; partially curing the high heat epoxy composition to form a prepreg; and laminating a plurality of prepregs; wherein the high heat epoxy composition comprises a high heat epoxy compound, and an auxiliary epoxy compound different from the high heat epoxy compound.

Processes useful for preparing the articles and materials include those generally known to the art for the processing of thermosetting polymers. Such processes have been described in the literature as in, for example, Engineered Materials Handbook, Volume 1, Composites, ASM International Metals Park, Ohio, copyright 1987 Cyril A. Distal Senior Ed, pp. 105-168 and 497-533, and “Polyesters and Their Applications” by Bjorksten Research Laboratories, Johan Bjorksten (pres.) Henry Tovey (Ch. Lit. Ass.), Betty Harker (Ad. Ass.), James Henning (Ad. Ass.), Reinhold Publishing Corporation, New York, 1956. Processing techniques include polymer transfer molding; sheet molding; bulk molding; pultrusion; injection molding, including reaction injection molding (RIM); atmospheric pressure molding (APM); casting, including centrifugal and static casting open mold casting; lamination including wet or dry lay up and spray lay up; also included are contact molding, including cylindrical contact molding; compression molding; including vacuum assisted polymer transfer molding and chemically assisted polymer transfer molding; matched tool molding; autoclave curing; thermal curing in air; vacuum bagging; pultrusion; Seeman's Composite Resin Infusion Manufacturing Processing (SCRIMP); open molding, continuous combination of polymer and glass; and filament winding, including cylindrical filament winding. In certain embodiments, an article can be prepared from the disclosed high heat epoxy compositions via a polymer transfer molding process.

In another aspect, disclosed is a material comprising the composite. The material can be a coating, an adhesive, a composite, an encapsulant, a sealant, or a combination thereof. The composite can be a glass fiber based composite, a carbon fiber based composite, or a combination thereof. The material can be produced by a polymer transfer molding process.

In another aspect, disclosed is an article comprising the composite. The article can be electrical components, computer components, printed circuit boards, and automotive, aircraft, and watercraft exterior or interior components. The article can be produced by a polymer transfer molding process.

The compositions and methods described herein are further illustrated by the following non-limiting examples.

### EXAMPLES

The materials listed in Table 1 were used.

TABLE 1

| Component | Description | Source |
|---|---|---|
| PPPBP-epoxy | 1,1-bis(4-epoxyphenyl)-N-phenylphthalimidine, with an epoxy equivalent | SABIC |
| | weight 252.5 grams/equivalent | |
| TGDDM | Tetraglycidyldiaminodiphenylmethane, CAS Reg. No. 28768-32-3; with an | Sigma-Aldrich |
| | epoxy equivalent weight of 109-117 grams/equivalent; obtained as 4,4′- | |
| | Methylenebis(N,N-diglycidylaniline) | |
| TGAP | N,N-Diglycidyl-4-glycidyloxyaniline, CAS Reg. No. 5026-74-4; with an | Sigma-Aldrich |
| | epoxy equivalent weight of 95-106 grams/equivalent | |
| ECN | Epoxy cresol novolac, CAS Reg. No. 29690-82-2 with an epoxy equivalent | Huntsman |
| | weight of 206-224 grams/equivalent, functionality about 5.1. Also | Advanced Materials |
| | referred to as ECN1280 | |
| MDEA | 4,4′-Methylenebis-(2,6-diethylaniline); CAS Reg. No. 13680-35-8 with an | Sigma-Aldrich |
| | amine equivalent weight of 154.7-157.6 grams/equivalent | |
| Carbon-fiber | Carbon fiber cloth HEXTOW IM7 PW (plain weave), Density of 1.78 | Hexcel |
| cloth | g/cm³ | |

Compositions were tested using the test methods listed in Table 2. Unless indicated otherwise, all test methods are the test methods in effect as of the filing date of this application.

TABLE 2

| Property | Units | Description (Conditions) | Test | Specimen |
|---|---|---|---|---|
| Glass transition | ° C. | TA Instruments 2920 M- | DSC | |
| temperature (T_{g}) | | DS. Scan range from 30 to | | |
| | | 250° C. under a nitrogen | | |
| | | atmosphere; heating rate of | | |
| | | 20° C./min. | | |
| Fracture | MPa-m^{0.5} | 23° C. | ASTM D5045 | Compact Tension Sample |
| toughness, KIC | | | | |
| Fracture | J/m² | 23° C. | ASTM D5045 | Compact Tension Sample |
| toughness, GIC | | | | |
| Maximum tensile | MPa | 23° C. | ASTM D3039 | 6 ply laminate, Ply (fiber) |
| stress | | | | orientations are 0 and 90 degrees to |
| | | | | the applied axial tensile stress (x- |
| | | | | direction, the direction of the applied |
| | | | | stresses) |
| Modulus | GPa | 23° C. | ASTM D3039 | 6 ply laminate. Ply (fiber) orientations |
| | | | | are 0 and 90 degrees to the applied |
| | | | | axial tensile stress (x-direction, the |
| | | | | direction of the applied stresses) |
| Compression | MPa | 23° C. | ASTM D6641 | 12 ply laminate. Ply (fiber) |
| Strength | | | | orientation are 0 and 90 degrees to the |
| | | | | applied compressive stress (x- |
| | | | | direction) |
| Short Beam Shear | MPa | 23° C. | ASTM D2344 | 12 ply short beam flat laminate. The |
| Strength | | | | specimen is loaded in three-point |
| | | | | bending apparatus with span |
| | | | | 11.18 mm, where the ply (fiber) |
| | | | | orientations are 0 and 90 degrees to |
| | | | | the applied stress (x-direction) |
| Maximum | Kg | | | |
| compressive load | | | | |
| (Maximum Load) | | | | |
| 45° In Plane | MPa | 23° C. | ASTM D3518 | 6 ply laminate |
| Shear Strength | | | | |
| 45° In Plane | GPa | 23° C. | ASTM D3518 | 6 ply laminate |
| Shear Modulus | | | | |
| Maximum | Mm | | | |
| Extension | | | | |
| Fiber Volume | % | | ASTM D317M | |

### Scanning Electron Microscopy

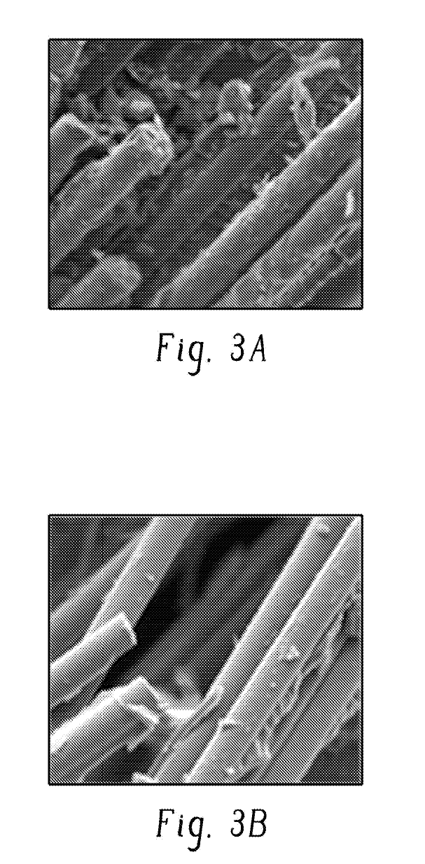

The tensile bars after tensile or shear tests were trimmed at both edges to fit in the size of sample chamber of Scanning electron Microscope. A carbon conductive paste was applied to the side walls of tensile bars near the fracture area to help to dissipate the electron build up on the surface and minimize the overcharging in the SEM images. After the complete drying of carbon paste, a thin layer of Gold/Palladium with thickness at a few nanometers was sputter coated on the top surface of the tensile bar. A Zeiss EVO 40 scanning electron microscope was employed to capture the SEM images. A moderate accelerating voltage was chosen to prevent the damage of electron on the fracture surfaces. A second electron detector was selected to reveal the surface morphology difference between control and PPPBP-Epoxy samples after shear tests. The SEM images (FIGS. 3A and 3B) indicate the control samples have a clean separation between polymer matrix and fiber and most of the fibers were directly pulled out from the matrix, indicating a weak adhesion between them. In contrast, in PPPBP-Epoxy samples, the fibers were still coated with layers of polymer material, and most of the fibers are still embedded in the matrix. The morphology of fiber in the PPPBP-Epoxy materials indicated a better compatibility between fiber and epoxy, which translated into a more effective load transfer between two phases during mechanical test, as corroborated by mechanical test results.

### Example 1. Castings

The performance of homogeneous, amorphous PPPBP-epoxy blends were tested in cast parts. The homogeneous, amorphous PPPBP-epoxy blend with TGAP (Example 1) was compared to a multi-functional epoxy blend made from ECN and TGDDM (Comparative Example A). Both blends were cured with MDEA. The polymer compositions were formulated with 15-17% excess epoxy equivalents.

The procedure for preparing castings involved blending the epoxy compounds together, then dissolving the MDEA in the warm epoxy compounds by warming and stirring. The warm, homogeneous epoxy/hardener solutions was degassed in a vacuum oven and then poured into a mold which was preheated to 140° C. The filled mold was placed in an oven at 140° C. and the cure temperature was programmed up to 220° C. Test parts were cut from the castings. Results of testing cast parts are provided in Table 3.

TABLE 3

| | Example 1 | Comparative Example A |
|---|---|---|
| PPPBP-epoxy, wt % | 67.67 | — |
| TGAP, wt % | 7.52 | — |
| ECN, wt % | — | 64.75 |
| TGDDM, wt % | — | 7.19 |
| MDEA, wt % | 24.81 | 28.06 |
| Tg, ° C. | | |
| DSC | 237.2 | 212.4 |
| DMA | 225.7 | 226.8 |
| Fracture toughness | | |
| K_{IC}, MPa-m^{0.5} | 0.52 | 0.46 |
| G_{IC}, J/m² | 161 | 137 |
| Gelation time (sec) | 3000 | 580 |

Example 1 exhibited physical property enhancements over Comparative Example A, including higher fracture toughness.

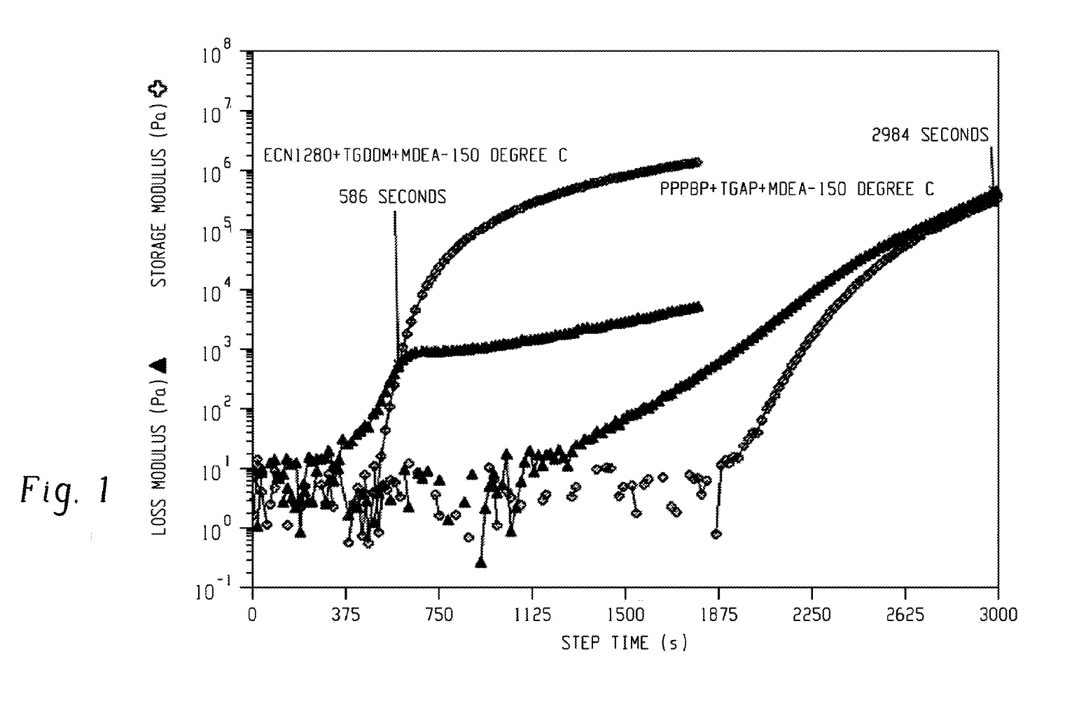

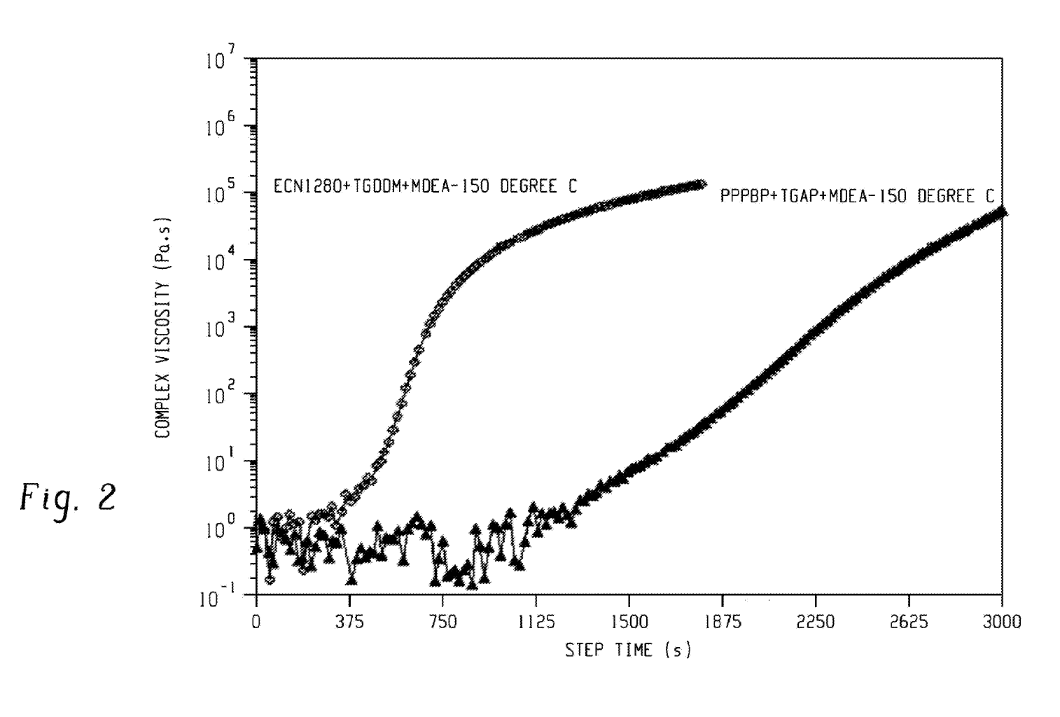

The gelation time of two formulations was tested. As shown in FIG. 1, Example 1 exhibits a much longer gelation time (G′-G″-cross over-onset of curing) than Comparative Example A. This provides better wetout properties in the prepreg, which improves laminar adhesion of the cured prepregs, and also allows thicker parts to be made, since residual stresses are better dissipated. In FIG. 2, rheological measurements were performed using a disposable 8 mm plate with 10% strain at a fixed gap of 1 mm using an ARES G2 strain controller Rheometer at 150° C. As shown in FIG. 2, Example 6 has a delayed onset and a slower viscosity increase compared to Comparative Example A.

### Examples 2 to 5. Prepregs

Polymer composition-carbon fiber composites were prepared using the polymer composition formulations provided in Example 1 and Comparative Example A.

The general procedure for preparing prepregs involved a film transfer route. In this two-step process, a polymer composition is precast as a film on carrier or release paper. In step one, the formulated compounds, which were warmed at 70° C., were cast onto release paper over rolls heated to about 70° C. In step two, the carbon fiber cloth was impregnated using the precast films on release paper. The carbon fiber cloth and the precast film/release paper were pulled through heated rolls (heated to 70° C.). The prepreg was sandwiched between the release papers. The sandwiched prepreg was pulled through heated compaction rolls, and then led through cooling rolls. In the final stage of the process, one of the carrier papers was removed and the final prepreg was rolled with the one carrier paper.

Laminates were prepared by vacuum bag molding. 12 or 6 layers of prepreg were stacked in the mold and the temperature was increased from ambient temperature to 176° C. under full vacuum and 60 pounds per square inch (PSI) pressure. The temperature was held at 176° C. for 14 hours. The laminate was cooled from 132° C. to ambient at 5.6° C./min. The pressure/vacuum was vented at ambient temperature. The laminates were post cured 215° C. for 3 hours. Laminates were cut into test parts and tested.

The presence of inter-laminar shear stress in the laminated composite leads to de-lamination. De-lamination is one of the damage modes in laminated composite materials. Inter-laminar shear stresses are the source of failure and a unique characteristic of composite structures. Inter-laminar shear stress arises due to various reasons. One factor contributing to inter-laminar strength is the matrix polymer between layers.

Table 4 provides results for in-plane tensile properties of laminates where the ply (fiber) orientations are 0 and 90 degrees to the applied axial tensile stress.

TABLE 4

| | Example 2 | | Comparative Example B | |
|---|---|---|---|---|
| | Mean | Standard | Mean | Standard |
| Matrix resin | Value | Deviation | Value | Deviation |
| formulation | Example 1 | | Comparative Example A | |
| Plies in laminate | 6 | — | 6 | — |
| Thickness, mm | 25.013 | 0.09 | 25.08 | 0.14 |
| Width, mm | 1.15 | 0.03 | 1.20 | 0.01 |
| Area, cm² | 0.288 | 0.007 | 0.300 | 0.004 |
| Cured Ply Thickness | 0.192 | | 0.199 | |
| Fiber volume, % | 57 | — | 55 | — |
| Maximum tensile | 855.16 | 33.62 | 763.25 | 20.14 |
| stress, Mpa | | | | |
| Modulus, Gpa | 73.2 | 1.37 | 68.73 | 4.16 |
| Maximum Load, kg | 2509.5 | 95.9 | 2337.0 | 67.9 |
| Normalized for 58% | | | | |
| fiber volume | | | | |
| Maximum tensile | 870.12 | — | 800.96 | — |
| stress, Mpa | | | | |
| Modulus, Gpa | 74.46 | — | 72.67 | — |

Example 2 exhibits higher tensile stress and modulus than Comparative Example B. After normalizing the results for 58% fiber volume, Example 2 also exhibits higher tensile stress and modulus than Comparative Example B.

Table 5 provides compressive strength and stiffness data of the laminates where the ply (fiber) orientations are 0 and 90 degrees to the applied compressive stress.

TABLE 5

| | Example 3 | | Comparative Example C | |
|---|---|---|---|---|
| | Mean | Standard | Mean | Standard |
| Matrix resin | Value | Deviation | Value | Deviation |
| formulation | Example 1 | | Comparative Example A | |
| Plies in laminate | 12 | — | 12 | — |
| Thickness, mm | 2.235 | 0.013 | 2.464 | 0.005 |
| Width, mm | 11.63 | 0.9 | 11.99 | 0.97 |
| Area, cm² | 0.260 | 0.021 | 0.295 | 0.024 |
| Cured Ply Thickness | 0.187 | | 0.205 | |
| Fiber volume, % | 58.7 | — | 53.4 | — |
| Compression Strength, | 493.61 | 24.33 | 385.89 | 57.62 |
| Mpa | | | | |
| Maximum | 1313.18 | 128.69 | 1160.02 | 206.62 |
| Compressive Load, kg | | | | |
| Normalized for 58% | | | | |
| fiber volume | | | | |
| Compression Strength, | 487.46 | — | 418.65 | — |
| Mpa | | | | |

Example 3 exhibits significantly higher compressive strength than Comparative Example C. After normalizing the results for 58% fiber volume, Example 3 also exhibits higher compressive strength than Comparative Example C.

Table 6 provides results for short beam shear strength of laminates in three-point bending configuration. The laminates were tested with the ply (fiber) orientations at 0 and 90 degrees to the applied stress.

TABLE 6

| | Example 4 | | Comparative Example D | |
|---|---|---|---|---|
| | Mean | Standard | Mean | Standard |
| Matrix resin | Value | Deviation | Value | Deviation |
| formulation | Example 1 | | Comparative Example A | |
| Plies in laminate | 12 | — | 12 | — |
| Thickness, mm | 2.235 | 0.018 | 2.438 | 0.018 |
| Width, mm | 6.55 | 0.046 | 6.043 | 0.054 |
| Gauge Length, mm | 11.18 | — | 11.18 | — |
| Cured Ply Thickness, | 0.187 | | 0.203 | |
| mm | | | | |
| Fiber volume, % | 58.5 | — | 54 | — |
| Short Beam Shear | 63.76 | 2.27 | 46.2 | 2.62 |
| Strength, Mpa | | | | |
| Maximum Compressive | 127.37 | 4.19 | 92.67 | 4.29 |
| Load, kg | | | | |

Example 4 exhibits higher short beam shear strength than Comparative Example D.

Table 7 provides results for in-plane shear response of laminates where the ply (fiber) orientations are ±45 degrees to the applied tensile stress.

TABLE 7

| | Example 5 | | Comparative Example E | |
|---|---|---|---|---|
| | Mean | Standard | Mean | Standard |
| Matrix resin | Value | Deviation | Value | Deviation |
| formulation | Example 1 | | Comparative Example A | |
| Plies in laminate | 6 | — | 6 | — |
| Thickness, mm | 25.17 | 0.11 | 25.17 | 0.03 |
| Width, mm | 1.165 | 0.023 | 1.182 | 0.021 |
| Gauge Length, mm | 101.6 | — | 101.6 | — |
| Cured Ply Thickness, | 0.192 | | 0.198 | |
| mm | | | | |
| Fiber volume, % | 57 | — | 55.35 | — |
| 45° In Plane Shear | 83.27 | 1.96 | 61.05 | 1.24 |
| Strength, Mpa | | | | |
| 45° In Plane Shear | 4.13 | 0.25 | 4.14 | 0.12 |
| Modulus, Gpa | | | | |
| Maximum Load, kg | 494.11 | 16.04 | 367.58 | 9.00 |
| Maximum Extension, | 11.97 | 0.96 | 10.55 | 0.83 |
| mm | | | | |

Example 5 exhibits significantly higher strength than Comparative Example E

For laminates, PPPBP-epoxy exhibits enhancements in performance compared to a reference polymer composition.

The compositions, methods, articles and other aspects are further described by the Embodiments below.

### Embodiment 1

A high heat epoxy prepreg, comprising a substrate, preferably carbon fibers; a high heat epoxy composition comprising: a hardener; a high heat epoxy mixture comprising: a high heat epoxy compound having formula:

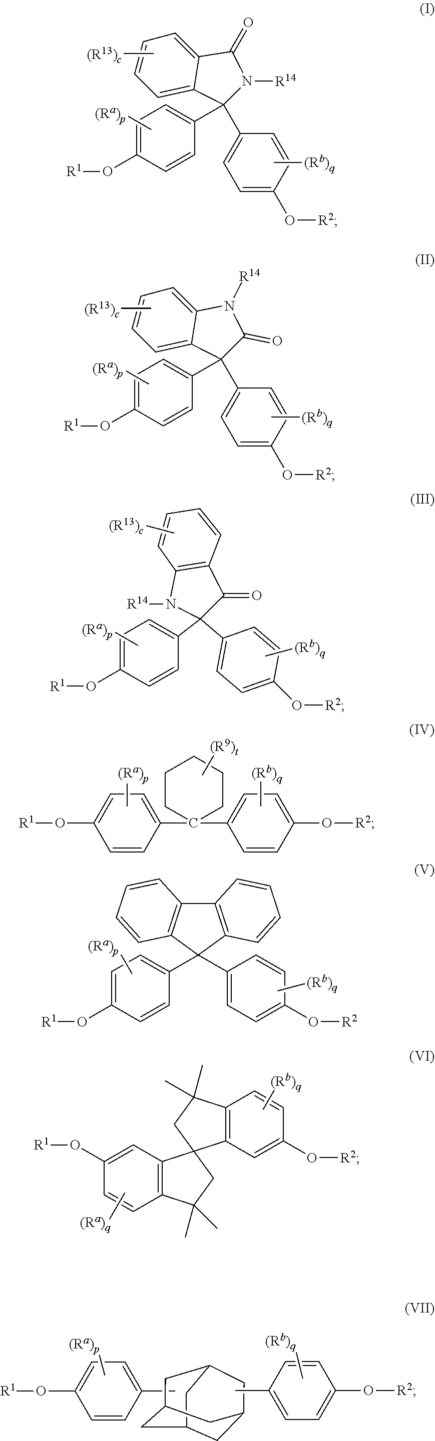

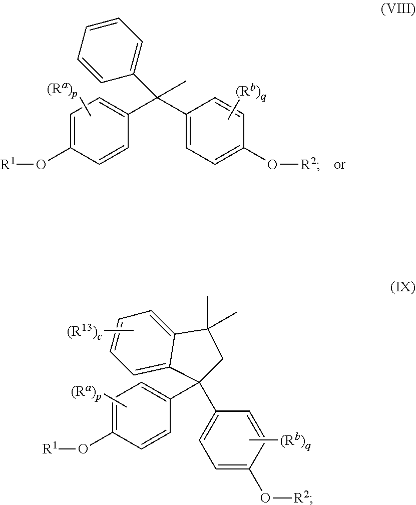

wherein R¹ and R² at each occurrence are each independently an epoxide-containing functional group; R^{a} and R^{b} at each occurrence are each independently halogen, C₁-C₁₂ alkyl, C₂-C₁₂ alkenyl, C₃-C₈ cycloalkyl, or C₁-C₁₂ alkoxy; p and q at each occurrence are each independently 0 to 4; R¹³ at each occurrence is independently a halogen or a C₁-C₆ alkyl group; c at each occurrence is independently 0 to 4; R¹⁴ at each occurrence is independently a C₁-C₆ alkyl, phenyl, or phenyl substituted with up to five halogens or C₁-C₆ alkyl groups; R^{g} at each occurrence is independently C₁-C₁₂ alkyl or halogen, or two R^{g} groups together with the carbon atoms to which they are attached form a four-, five, or six-membered cycloalkyl group; and t is 0 to 10; and an auxiliary epoxy compound different from the high heat epoxy compound; wherein the high heat epoxy mixture has a glass transition temperature between −10° C. and 62° C., preferably between 15° C. and 62° C., preferably between 30° C. and 62° C., preferably between 40° C. and 62° C., wherein the prepreg comprises 40 to 80 volume %, preferably 50 to 70 volume % substrate, and 60 to 20 volume % of the high heat epoxy composition, wherein the prepreg comprises 12 to 45 volume % of the compound having formula (I) to (IX); wherein the high heat epoxy composition comprises 50 to 75 wt % of the compound having formula (I) to (IX); and a cured, laminated sample of the prepreg has a maximum tensile stress of 800 MPa or greater, measured as per ASTM D 3039, and a modulus of 70 GPa or greater measured as per ASTM D 3039; and a cured sample of the high heat epoxy composition has a glass transition temperature greater than 200° C., preferably greater than 220° C., preferably greater than 230° C.

### Embodiment 1A

The high heat epoxy prepreg of Embodiment 1, wherein the high heat epoxy composition displays a gelation time longer than 600 seconds (sec), longer than 1000 sec, longer than 2000 sec, or longer than 2500 sec.

### Embodiment 2

The prepreg of Embodiment 1, wherein the auxiliary epoxy compound is an aliphatic epoxy compound, cycloaliphatic epoxy compound, aromatic epoxy compound, bisphenol A epoxy compound, bisphenol-F epoxy compound, phenol novolac epoxy polymer, cresol-novolac epoxy polymer, biphenyl epoxy compound, triglycidyl p-aminophenol, tetraglycidyl diamino diphenyl methane, polyfunctional epoxy compound, naphthalene epoxy compound, divinylbenzene dioxide compound, 2-glycidylphenylglycidyl ether, dicyclopentadiene-type epoxy compound, multi aromatic type epoxy polymer, or a combination comprising at least one of the foregoing.

### Embodiment 3

The prepreg of Embodiment 1 or 2, wherein the auxiliary epoxy compound is a bisphenol A diglycidylether, a bisphenol F diglycidylether, a neopentylglycol diglycidyl ether, a 3,4-epoxycyclohexylmethyl-3,4-epoxycyclohexane carboxylate, a N,N-diglycidyl-4-glycidyloxyaniline, a N,N,N′,N′-tetraglycidyl-4,4′-diaminodiphenylmethane, or a combination comprising at least one of the foregoing.

### Embodiment 4

The prepreg of any one or more of Embodiments 1 to 3, comprising 1 to 50 wt %, preferably 1 to 25 wt %, preferably 1 to 10 wt % of the auxiliary epoxy compound.

### Embodiment 5

The prepreg of any one or more of Embodiments 1 to 4, wherein the substrate comprises a woven fabric, non-woven fabric, plain weave cloth, satin weave cloth, non-crimp fabric, unidirectional fibers, braid, tow, end, rope, a high modulus carbon-fiber, intermediate modulus carbon-fiber, high strength carbon-fiber, E-glass, S-glass, aramid fiber, or a combination comprising at least one of the foregoing.

### Embodiment 6

The prepreg of any one or more of Embodiments 1 to 5, wherein R1 and R2 at each occurrence are each independently:

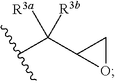

wherein R^{3a} and R^{3b} are each independently hydrogen or C1-C12 alkyl.

### Embodiment 7

The prepreg of any one or more of Embodiments 1 to 6, wherein the high heat epoxy compound has the formula (1-a), (2-a), or (4-b)

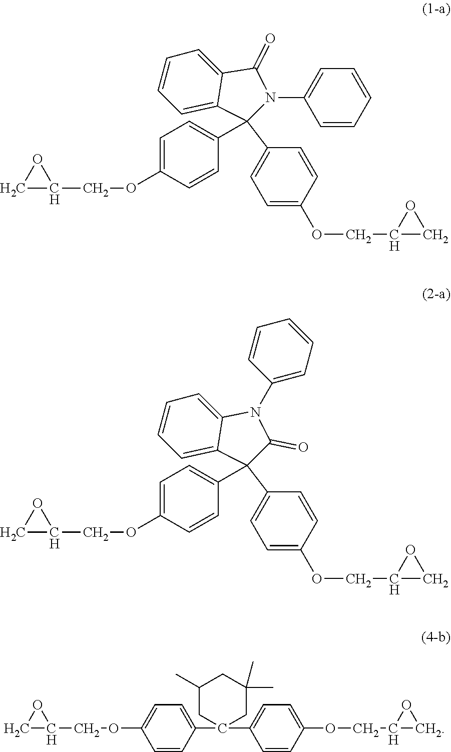 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

### Embodiment 8

The prepreg of any one or more of Embodiments 1 to 7, wherein the hardener is an aromatic diamine compound, preferably wherein the aromatic diamine compound comprises 4-aminophenyl sulfone (DDS), 3-aminophenyl sulfone, 4,4′-methylenedianiline, diethyltoluenediamine, 4,4′-methylenebis (2,6-diethyl aniline), m-phenylenediamine, p-phenylenediamine, 2,4-bis(p-aminobenzyl)aniline, 3,5-diethyltoluene-2,4-diamine, 3,5-diethyltoluene-2,6-diamine, m-xylylenediamine, p-xylylenediamine, diethyl toluene diamines, or a combination comprising at least one of the foregoing.

### Embodiment 9

A method of manufacturing the high heat epoxy based prepreg of Embodiment 1, comprising coating the substrate with the high heat epoxy composition to form the PPPBP-epoxy based prepreg.

### Embodiment 10

The method of Embodiment 9, wherein coating comprises immersing the substrate into the high heat epoxy composition, preferably for up to 30 minutes; spraying the high heat epoxy composition onto the substrate; curtain coating the substrate with the high heat epoxy composition; pouring the high heat epoxy composition onto the substrate; or a combination comprising at least one of the foregoing.

### Embodiment 11

The method of Embodiment 9 or 10, wherein the substrate comprises a woven fabric, non-woven fabric, plain weave cloth, satin weave cloth, non-crimp fabric, unidirectional fibers, braid, tow, end, rope, a high modulus carbon-fiber, intermediate modulus carbon-fiber, high strength carbon-fiber, E-glass, S-glass, aramid fiber, or a combination comprising at least one of the foregoing.

### Embodiment 12

A prepreg formed by the method of any one or more of Embodiments 9 to 11.

### Embodiment 13

A high heat epoxy composite produced by consolidating a prepreg of any one or more of Embodiments 1 to 8.

### Embodiment 14

The composite of Embodiment 13, in the form of a laminate produced by consolidating at least two, preferably from two to one hundred layers of the prepreg under heat and pressure.

### Embodiment 15

The composite of Embodiment 13, wherein the prepreg layers are in the form of continuous unidirectional fiber-reinforced tapes, or wherein the composite is thermoformed to form a shape.

### Embodiment 16

The composite of any one or more of Embodiments 13 to 15, wherein a gelation time of the high heat epoxy composition at 150° C. is at least 10% slower, or 10 to 70% slower, or 10 to 50% slower than a gelation time at 150° C. of a composition comprising an epoxy cresol novolac and a multi-functional epoxy resin.

### Embodiment 17

The composite of any one or more of Embodiments 13 to 16, where the gelation time of the high heat epoxy composition is longer than 1000 seconds, longer than 2000 seconds, or longer than 2500 sec.

### Embodiment 18

The composite of any one or more of Embodiments 13 to 15, wherein the composite is thermoformed to form a shape.

### Embodiment 19

The composite of any one or more of Embodiments 13 to 16, wherein a cured, laminated sample of the composite has a compression strength of 450 MPa or greater, measured as per ASTM D 6641.

### Embodiment 20

The composite of any one or more of Embodiments 13 to 16, wherein a cured, laminated sample of the composite has a 45° In Plane Shear strength of 80 MPa or greater, measured as per ASTM D3518; and a 45° In Plane Shear modulus of 4 GPa or greater, measured as per ASTM D3518.

### Embodiment 19

The composite of any one or more of Embodiments 13 to 16, wherein a cured, laminated sample of the composite has a Short Beam Shear strength of 60 MPa or greater measured as per ASTM D 2344; and a Short Beam Shear modulus of 120 GPa or greater measured as per ASTM D 2344.

### Embodiment 20

An article comprising the composite of any one or more of Embodiments 13 to 19.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

The singular forms “a,” “an,” and “the” include plural referents unless the context clearly dictates otherwise. “Or” means “and/or” unless clearly indicated otherwise by context.

The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. Unless defined otherwise, technical and scientific terms used herein have the same meaning as is commonly understood by one of skill in the art to which this disclosure belongs. A “combination” is inclusive of blends, mixtures, alloys, reaction products, and the like.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “alkylidene” refers to a straight or branched chain, saturated divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicyclic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (-0-); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., =0), then two hydrogens on the atom are replaced. Combinations of substituents or variables are permissible provided that the substitutions do not significantly adversely affect synthesis or use of the compound. Exemplary groups that can be present on a “substituted” position include, but are not limited to, cyano; hydroxyl; nitro; azido; alkanoyl (such as a C₂₋₆ alkanoyl group such as acyl); carboxamido; C₁₋₆ or C₁₋₃ alkyl, cycloalkyl, alkenyl, and alkynyl (including groups having at least one unsaturated linkages and from 2 to 8, or 2 to 6 carbon atoms); C₁₋₆ or C₁₋₃ alkoxys; C₆₋₁₀ aryloxy such as phenoxy; C₁₋₆ alkylthio; C₁₋₆ or C₁₋₃ alkylsulfinyl; C₁₋₆ or C₁₋₃ alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇₋₁₉ arylalkyl having 1 to 3 separate or fused rings and from 6 to 18 ring carbon atoms; or arylalkoxy having 1 to 3 separate or fused rings and from 6 to 18 ring carbon atoms, with benzyloxy being an exemplary arylalkoxy. As is typical in the art, a line extending from a structure signifies a terminating methyl group —CH₃.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A high heat epoxy prepreg, comprising:
a substrate; and
a high heat epoxy composition comprising:
a hardener; and
a high heat epoxy mixture comprising:
a high heat epoxy compound having formula: 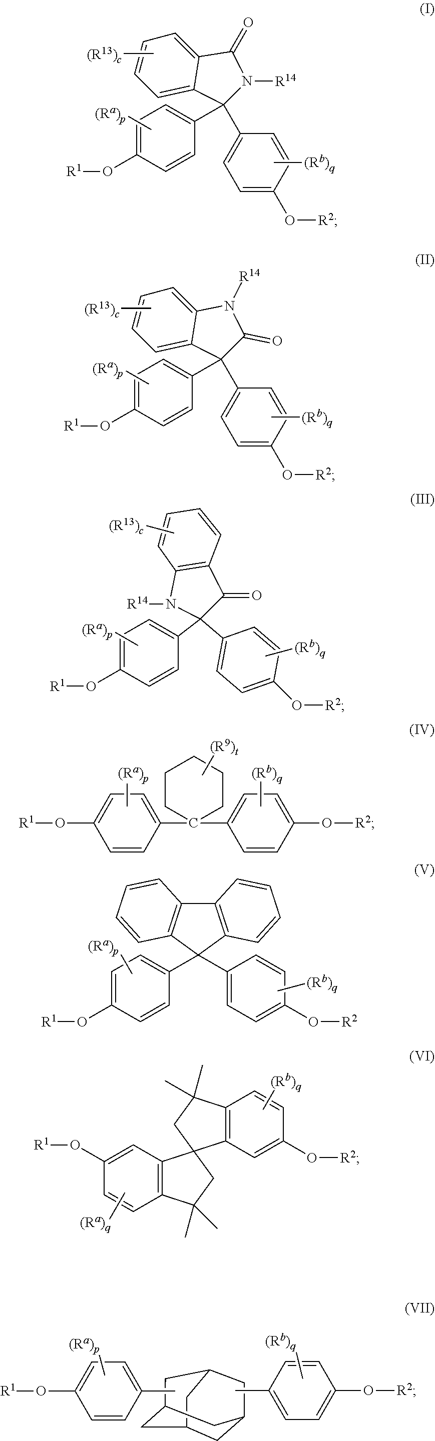 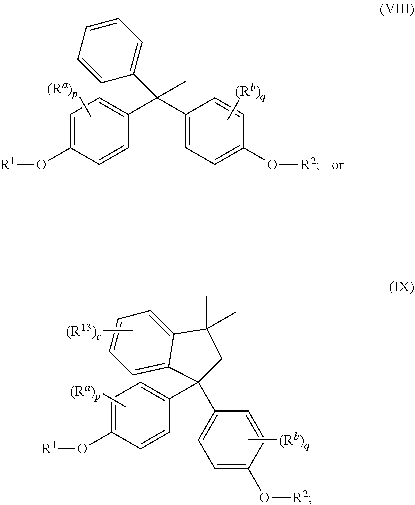
wherein
R¹ and R² at each occurrence are each independently an epoxide-containing functional group;
R^{a} and R^{b} at each occurrence are each independently halogen, C₁-C₁₂ alkyl, C₂-C₁₂ alkenyl, C₃-C₈ cycloalkyl, or C₁-C₁₂ alkoxy;
p and q at each occurrence are each independently 0 to 4;
R¹³ at each occurrence is independently a halogen or a C₁-C₆ alkyl group;
c at each occurrence is independently 0 to 4; R¹⁴ at each occurrence is independently a C₁-C₆ alkyl, phenyl, or phenyl substituted with up to five halogens or C₁-C₆ alkyl groups;
R^{g} at each occurrence is independently C₁-C₁₂ alkyl or halogen, or two R^{g} groups together with the carbon atoms to which they are attached form a four-, five, or six-membered cycloalkyl group; and
t is 0 to 10; and
an auxiliary epoxy compound different from the high heat epoxy compound,
wherein the high heat epoxy mixture has a glass transition temperature between −10° C. and 62° C.,
wherein
the prepreg comprises
40 to 80 volume %, preferably 50 to 70 volume % of the substrate, and
60 to 20 volume % of the high heat epoxy composition, and
the prepreg comprises 12 to 45 volume % of the compound having formula (I) to (IX);
wherein the high heat epoxy composition comprises 50 to 75 wt % of the compound having formula (I) to (IX); and
wherein
a cured, laminated sample of the prepreg has a maximum tensile stress of 800 MPa or greater, measured as per ASTM D 3039, and a modulus of 70 GPa or greater, measured as per ASTM D 3039, and
and a cured, laminated sample of the high heat epoxy composition has a glass transition temperature of greater than 200° C.

2. The high heat epoxy prepreg of claim 1, wherein the high heat epoxy composition displays a gelation time of longer than 600 seconds.

3. The prepreg of claim 1, wherein the auxiliary epoxy compound is selected from an aliphatic epoxy compound, cycloaliphatic epoxy compound, aromatic epoxy compound, bisphenol A epoxy compound, bisphenol-F epoxy compound, phenol novolac epoxy polymer, cresol-novolac epoxy polymer, biphenyl epoxy compound, triglycidyl p-aminophenol, tetraglycidyl diamino diphenyl methane, polyfunctional epoxy compound, naphthalene epoxy compound, divinylbenzene dioxide compound, 2-glycidylphenylglycidyl ether, dicyclopentadiene-type epoxy compound, multi aromatic type epoxy polymer, or a combination thereof.

4. The prepreg of claim 1, wherein the auxiliary epoxy compound is a bisphenol A diglycidylether, a bisphenol F diglycidylether, a neopentylglycol diglycidyl ether, a 3,4-epoxycyclohexylmethyl-3,4-epoxycyclohexane carboxylate, N,N-diglycidyl-4-glycidyloxyaniline, a N,N,N′,N′-tetraglycidyl-4,4′-diaminodiphenylmethane, or a combination thereof.

5. The prepreg of claim 1, comprising 1 to 50 wt % of the auxiliary epoxy compound.

6. The prepreg of claim 1, wherein the substrate is a woven fabric, non-woven fabric, plain weave cloth, satin weave cloth, non-crimp fabric, unidirectional fibers, braid, tow, end, rope, a high modulus carbon-fiber, intermediate modulus carbon-fiber, high strength carbon-fiber, E-glass, S-glass, aramid fiber, or a combination.

7. The prepreg of claim 1, wherein R¹ and R² at each occurrence are each independently: 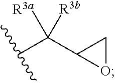
wherein R^{3a} and R^{3b} are each independently hydrogen or C₁-C₁₂ alkyl.

8. The prepreg of claim 1, wherein the high heat epoxy compound has the formula (1-a), (2-a), or (4-b)

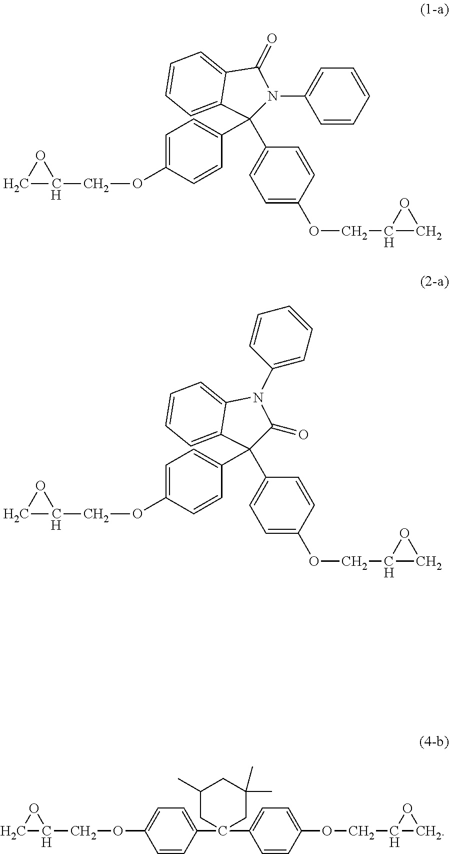 [SMILES: O=C1c2ccccc2C(c2ccc(OCC3CO3)cc2)(c2ccc(OCC3CO3)cc2)N1c1ccccc1 ; O=C1N(c2ccccc2)c2ccccc2C1(c1ccc(OCC2CO2)cc1)c1ccc(OCC2CO2)cc1 ; CC1CC(C)(C)CC(c2ccc(OCC3CO3)cc2)(c2ccc(OCC3CO3)cc2)C1]

9. The prepreg of claim 1, wherein the hardener is an aromatic diamine compound.

10. A method of manufacturing the high heat epoxy prepreg of claim 1, the method comprising: coating the substrate with the high heat epoxy composition to form the high heat epoxy prepreg.

11. The method of claim 9, wherein the coating comprises immersing the substrate into the high heat epoxy composition; spraying the high heat epoxy composition onto the substrate; curtain coating the substrate with the high heat epoxy composition; pouring the high heat epoxy composition onto the substrate; or a combination thereof.

12. The method of claim 10, wherein the substrate is a woven fabric, non-woven fabric, plain weave cloth, satin weave cloth, non-crimp fabric, unidirectional fibers, braid, tow, end, rope, a high modulus carbon-fiber, intermediate modulus carbon-fiber, high strength carbon-fiber, E-glass, S-glass, aramid fiber, or a combination thereof.

13. A prepreg formed by the method of claim 10.

14. A high heat epoxy composite produced by consolidating the high heat epoxy prepreg of claim 1.

15. The composite of claim 14, in the form of a laminate produced by consolidating at least two layers of the high heat epoxy prepreg under heat and pressure.

16. The composite of claim 14, wherein the prepreg layers are in the form of continuous unidirectional fiber-reinforced tapes, or wherein the composite is thermoformed to form a shape.

17. The composite of claim 14, wherein a gelation time of the high heat epoxy composition at 150° C. is at least 10% slower than a gelation time at 150° C. of a composition comprising an epoxy cresol novolac and a multi-functional epoxy resin.

18. The composite of claim 17, wherein the gelation time of the high heat epoxy composition is longer than 1,000 seconds.

19. The composite of claim 14, wherein a cured, laminated sample of the composite has a compression strength of 450 MPa or greater, measured as per ASTM D 6641.

20. The composite of claim 14, wherein a cured, laminated sample of the composite has
a 45° In Plane Shear strength of 80 MPa or greater, measured as per ASTM D3518; and
a 45° In Plane Shear modulus of 4 GPa or greater, measured as per ASTM D3518.

21. The composite of claim 14, wherein a cured, laminated sample of the composite has
a Short Beam Shear strength of 60 MPa or greater measured as per ASTM D 2344; and
a Short Beam Shear modulus of 120 GPa or greater measured as per ASTM D 2344.

22. An article comprising the composite of claim 14.
